(19) United States
(12) Patent Application Publication
(10) Pub. No.: US 2013/0346529 A1
(43) Pub. Date: Dec. 26, 2013

(54) METHOD, DEVICE AND SYSTEM FOR ADDING MICRO-BLOG MESSAGE AS FAVORITE

(71) Applicant: Tencent Technology (Shenzhen) Company Limited, Shenzhen (CN)

(72) Inventor: Yu Ku, Shenzhen (CN)

(73) Assignee: Tencent Technology (Shenzhen) Company Limited, Shenzhen (CN)

(21) Appl. No.: 14/012,719

(22) Filed: Aug. 28, 2013

Related U.S. Application Data
(63) Continuation of application No. PCT/CN2012/077250, filed on Jun. 20, 2012.

(30) Foreign Application Priority Data
Sep. 5, 2011 (CN) CN 201110261036.1

(51) Int. Cl. H04L 12/58

(52) U.S. Cl. CPC H04L 51/36
USPC 709/206

(57) ABSTRACT

The present invention provides a method for adding a micro-blog message as favorite, comprising the following steps: acquiring, by a micro-blog client device, an instruction from a user for adding a micro-blog message as favorite; setting, by the micro-blog client device, a favorite tag for the micro-blog message added as favorite by the user; and sending, by the micro-blog client device, an identifier of the micro-blog message with the favorite tag to a server. The method improves the operation convenience. Also provided are a system for adding a micro-blog message as favorite and a micro-blog client.

### CROSS-REFERENCES TO RELATED APPLICATIONS

This application is a continuation of International Application No. PCT/CN2012/077250, filed on Jun. 20, 2012, which claims priority to Chinese patent application No. 2011102610361, filed with the State Intellectual Property Office of PRC on Sep. 5, 2011, which are incorporated herein by reference in their entirety.

### FIELD OF THE INVENTION

The invention relates to the Internet technology, and in particular to a method and a system for adding a micro-blog message as favorite, a micro-blog client device and a storage medium.

### BACKGROUND OF THE INVENTION

With the development of Internet applications, the application of micro-blog is developed continuously. The so-called micro-blog refers to a mini-size blog, by which a user may express an idea with around a hundred of characters or a sentence, and the posted micro-blog may be spread and transferred fast over the network. The micro-blog may lead to a change of an information exchange pattern for users from a one-to-one type or a one-to-multiple type to a one-to-infinity type. That is, one user may spread information to infinite number of users, and may also read information posted by thousands of other users.

In a conventional micro-blog client device, the number of micro-blog messages followed by a user is huge, and the number of micro-blog messages displayed on the interface increases with the increasing number of messages received by the user. Therefore if the user wants to read or repost a message of interest which he/she read before, the user has to search for the message one by one, resulting in an inconvenience for the user.

### SUMMARY OF THE INVENTION

In view of the above, it is needed to provide a method for adding a micro-blog message as favorite, which can improve the operation convenience.

A method for adding a micro-blog message as favorite includes steps of:

acquiring, by a micro-blog client device, an instruction from a user for adding a micro-blog message as favorite;

setting, by the micro-blog client device, a favorite tag for the micro-blog message added as favorite by the user; and

sending, by the micro-blog client device, an identifier of the micro-blog message with the favorite tag to a server.

Further, it is also needed to provide a micro-blog client device capable of improving the operation convenience.

A micro-blog client device includes: an operation responding module configured to acquire an instruction from a user for adding a micro-blog message as favorite; and a tagging module configured to set a favorite tag for the micro-blog message added as favorite by the user and to send an identifier of the micro-blog message with the favorite tag to a server.

Further, it is also needed to provide a system for adding a micro-blog message as favorite, which can improve the operation convenience.

A system for adding a micro-blog message as favorite includes a micro-blog client device and a server interacting with the micro-blog client device, where the micro-blog client device includes:

an operation responding module configured to acquire an instruction from a user for adding a micro-blog message as favorite; and

a tagging module configured to set a favorite tag for the micro-blog message added as favorite by the user and to send an identifier of the micro-blog message with the favorite tag to the server; and

the server includes a message storage module configured to record the identifier into a favorite list.

Further, there is further provided one or more storage media including computer-executable instructions for performing a method for adding a micro-blog message as favorite. The method includes: acquiring, by a micro-blog client device, an instruction from a user for adding a micro-blog message as favorite; setting, by the micro-blog client device, a favorite tag for the micro-blog message added as favorite by the user; and sending, by the micro-blog client device, an identifier of the micro-blog message with the favorite tag to a server, for recording.

In the method, system, micro-blog client device and storage medium for adding a micro-blog message as favorite, the micro-blog client device sets a favorite tag for a micro-blog message added as favorite by a user after acquiring an instruction from the user for adding the micro-blog message as favorite, and the server records the identifier of the micro-blog message with the favorite tag into the favorite list. Because a unified management is performed on micro-blog messages added as favorite by a user, the user may find a micro-blog message added as favorite with high convenience, and the convenience in manipulating the micro-blog message is improved.

### BRIEF DESCRIPTION OF THE DRAWINGS

FIG. 1 is a flowchart of a method for adding a micro-blog message as favorite according to an embodiment;

FIG. 2 is a flowchart of a method for adding a micro-blog message as favorite according to another embodiment;

FIG. 3 is a schematic structural diagram of a system for adding a micro-blog message as favorite according to an embodiment; and

FIG. 4 is a schematic structural diagram of a system for adding a micro-blog message as favorite according to another embodiment.

### DETAILED DESCRIPTION OF THE INVENTION

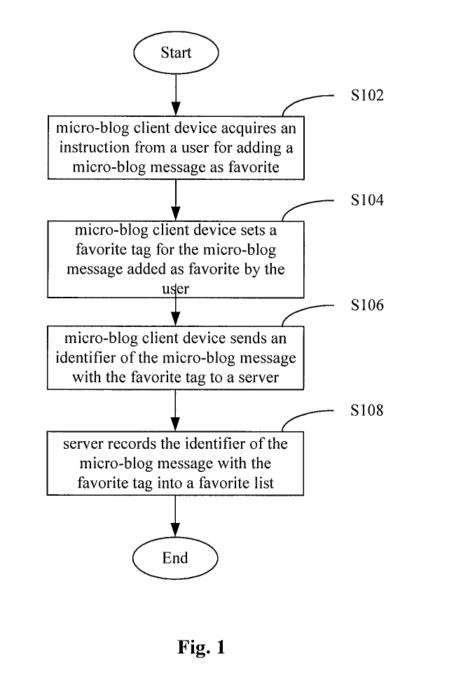

In an embodiment, as shown in FIG. 1, a method for adding a micro-blog message as favorite includes the following steps.

Step S102, acquiring, by a micro-blog client device, an instruction from a user for adding a micro-blog message as favorite.

The micro-blog client device may be a Web browser client device or an instant communication client device. If the micro-blog client device is an instant communication client device, a Tab page may be created on the instant communication client device to present acquired micro-blog message(s) on the Tab page.

A control for adding as favorite is set to receive an operation for adding as favorite of a user. When a micro-blog message is pulled and presented by the micro-blog client device, the user may operate on the control for adding as favorite to trigger an instruction for adding the micro-blog message as favorite. For example, a function item of adding as favorite may be set on a right-click menu for the user to select to trigger the instruction for adding the micro-blog message as favorite. Alternatively, a button of adding as favorite may be set on the micro-blog message page for the user to click to trigger the instruction for adding the micro-blog message as favorite.

Step S104, setting, by the micro-blog client device, a favorite tag for the micro-blog message added as favorite by the user.

The favorite tag for the micro-blog message may be set on the page where the micro-blog message is displayed. For example, a triangle icon may be set on the lower right corner of the micro-blog message to indicate that the micro-blog message is added as favorite by the user.

Step S106, sending, by the micro-blog client device, an identifier of the micro-blog message with the favorite tag to a server.

The identifier of the micro-blog message may be a unique ID. Sending the identifier of the micro-blog message with the favorite tag to a server facilitates the server to perform a unified management on micro-blog messages added as favorite by the user.

Step S108, recording, by the server, the identifier of the micro-blog message with the favorite tag into a favorite list.

The server stores a huge number of micro-blog messages. The micro-blog client device may upload a micro-blog message to the server after a user posts the micro-blog via the micro-blog client device. When a follower of the user logs in via the micro-blog client device, the micro-blog client device may pull the micro-blog message(s) from the server. The server maintains a corresponding favorite list for each user and identifier(s) for micro-blog message(s) added as favorite by the user is recorded in the favorite list.

Since the server performs a unified management on micro-blog messages with favorite tags, a favorite page may be set to present all of the micro-blog messages added as favorite by the user. When the user wants to read again and repost a micro-blog message added as favorite, the user may operate on the micro-blog message added as favorite by simply entering in the favorite page. Therefore, the operation convenience is improved.

In an embodiment, after the Step S104, the method further includes a step of recording, by the micro-blog client device, the identifier of the micro-blog message with the favorite tag into a local buffer list. In this embodiment, a pool is set in the local buffer to store the message(s) pulled by the micro-blog client device. A portion of storage for the undesired micro-blog messages may be released when the number of messages in the pool reaches to a set threshold. In pulling a micro-blog message from the server, it is determined whether the message to be pulled exists in the pool, and if the message exists in the pool, the micro-blog message is pulled directly from the pool instead of the server. Therefore, the traffic in the network may be saved and also the load of the server may be reduced.

A favorite list, i.e. the local buffer list, is also maintained in the local buffer. When a micro-blog client device sets a favorite tag for a micro-blog message added as favorite by a user, an identifier of the micro-blog message with the favorite tag is recorded in the local buffer list. When the micro-blog message(s) added as favorite needs to be presented, for example, when the user looks through pages in a Web browser or drags a scroll bar in a micro-blog message Tab page to read the micro-blog messages pulled before, the micro-blog client device determines whether the micro-blog message to be presented has been added as favorite, that is, the micro-blog client device checks whether the identifier of the micro-blog message exists in the local buffer list, and if the identifier of the micro-blog message exists in the local buffer list, a favorite tag is set for the micro-blog message; otherwise, it is indicated that the micro-blog message is not added as favorite by the user.

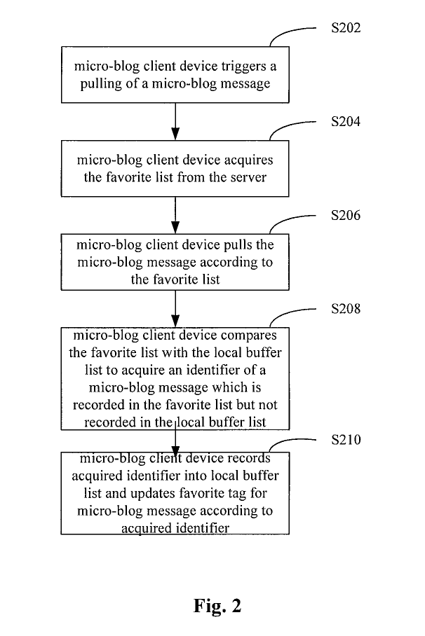

In another embodiment, as shown in FIG. 2, the method for adding a micro-blog message as favorite further includes the following steps.

Step S202, triggering, by the micro-blog client device, a pulling of a micro-blog message.

In an embodiment, a pulling of a micro-blog message may be triggered by operating a control of favorite page to display the favorite page of micro-blog messages, or by entering a micro-blog message Tab page and dragging a scroll bar.

Step S204, acquiring, by the micro-blog client device, the favorite list from the server.

Step S206, pulling, by the micro-blog client device, the micro-blog message according to the favorite list.

In an embodiment, the micro-blog client device calls a class for managing strategic pulling of favorite micro-blog messages in a class of favorite management logic through the control of favorite page, so as to pull a message. The class of favorite management logic hands the pulling action to a favorite logic executer to execute the pull action. A class for executing the pulling of favorite micro-blog messages in the underlying favorite manager is called to pull the favorite list and acquire an identifier of a micro-blog message added as favorite in the list.

In an embodiment, it is determined that whether the favorite list is pulled successfully, and if the favorite list is not pulled successfully, a failure prompt is displayed; if the favorite list is pulled successfully, it is further determined that whether the number of favorites in the favorite list is 0. If the number of favorites is 0, it is displayed that the number of favorites is 0; otherwise, the micro-blog message(s) recorded in the favorite list is pulled. In pulling a micro-blog message recorded in the favorite list, the micro-blog message is pulled from the local pool firstly, and if the micro-blog message can not be pulled from the local pool, the micro-blog message is pulled from the server. Subsequently, it is determined whether the micro-blog message is pulled successfully, and if it is failed, a failure prompt is displayed; otherwise, the pulled micro-blog message is presented on a page.

Step S208, comparing, by the micro-blog client device, the favorite list with the local buffer list to acquire an identifier of a micro-blog message which is recorded in the favorite list but not recorded in the local buffer list.

The micro-blog client device may compare the acquired favorite list with the local buffer list, and the micro-blog message which is recorded in the favorite list but not recorded in the local buffer list is a newly added favorite.

Step S210, recording, by the micro-blog client device, the acquired identifier into the local buffer list and updates the favorite tag for the micro-blog message according to the acquired identifier.

If there is a newly added favorite, the identifier of the micro-blog message newly added as favorite is recorded into the local buffer list; furthermore, each page is notified to check whether the micro-blog message(s) in the page is the newly added favorite, and if the micro-blog message(s) is the newly added favorite, a favorite tag is set for the micro-blog message newly added as favorite.

In an embodiment, the method for adding a micro-blog message as favorite further includes the step of canceling from favorite, which may include: acquiring, by the micro-blog client device, an instruction from a user for canceling a micro-blog message from favorite, and sending, by the micro-blog client device, the instruction to the server; removing, by the micro-blog client device, the favorite tag for the micro-blog message which is canceled from favorite by the user, and removing, by the micro-blog client device, from the local buffer list, the identifier of the micro-blog message which is canceled from favorite by the user; and removing, by the sever, from the favorite list, the identifier of the micro-blog message which is canceled from favorite by the user.

In the way described above, the user operates a control of canceling from favorite to trigger an instruction for canceling from favorite. After the user cancels a micro-blog message from favorite, the server correspondingly removes, from the favorite list, the identifier of the micro-blog message which is canceled from favorite. When the user enters the favorite page again, the micro-blog message which is canceled from favorite is not pulled according to the favorite list.

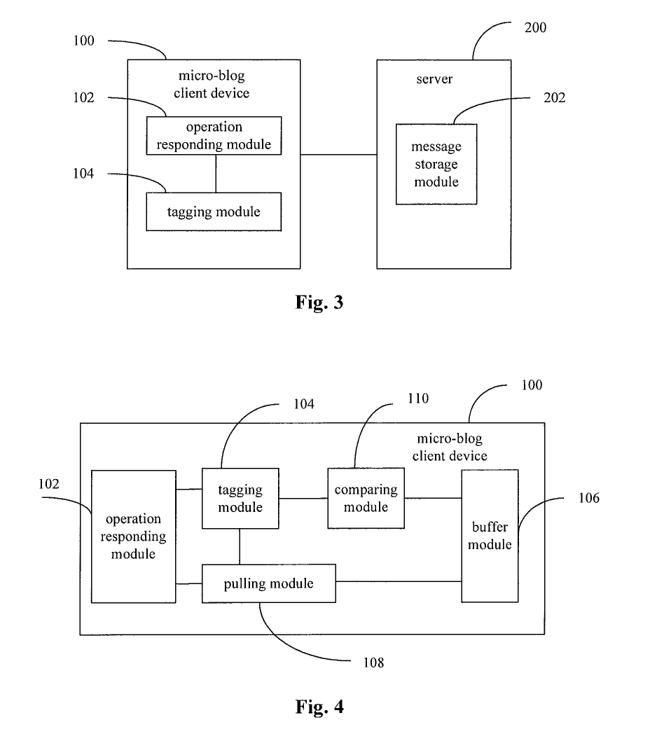

In an embodiment, as shown in FIG. 3, a system for adding a micro-blog message as favorite includes a micro-blog client device 100 and a server 200 interacting with the micro-blog client device 100. The micro-blog client device 100 includes an operation responding module 102 and a tagging module 104, and the server 200 includes a message storage module 202.

The operation responding module 102 is configured to acquire an instruction from a user for adding a micro-blog message as favorite.

The micro-blog client device 100 may be a Web browser client device or an instant communication client device. If the micro-blog client device 100 is an instant communication client device, a Tab page may be created on the instant communication client device to present a pulled micro-blog message on the Tab page. In an embodiment, the operation responding module 102 is configured to receive an instruction from a user for adding a micro-blog message as favorite through a control for adding as favorite.

The tagging module 104 is configured to set a favorite tag for the micro-blog message added as favorite by the user, and to send an identifier of the micro-blog message with the favorite tag to the server 200.

In an embodiment, the favorite tag for the micro-blog message may be set on the page where the micro-blog message is displayed. For example, a triangle icon may be set on the lower right corner of the micro-blog message to indicate that the micro-blog message is added as favorite by the user.

The message storage module 202 is configured to record the identifier of the micro-blog message with the favorite tag into a favorite list.

The message storage module 202 of the server 200 also stores a huge number of micro-blog messages. The micro-blog client device 100 may upload a micro-blog message to the server 200 for storing in the message storage module 202, after a user posts the micro-blog via the micro-blog client device 100. When a follower of the user logs in via the micro-blog client device, the micro-blog client device 100 may pull the micro-blog message(s) from the server 200. The server 200 maintains a corresponding favorite list for each user and the favorite list records identifiers for micro-blog messages added as favorite by the user.

Since the server 200 performs a unified management on micro-blog messages with favorite tags, a favorite page of micro-blog messages may be set to present all of the micro-blog messages added as favorite by the user. When a user wants to read again and repost a micro-blog message added as favorite, the user may operate the micro-blog message added as favorite by simply entering in the favorite page. Therefore, the operation convenience is improved.

In an embodiment, as shown in FIG. 4, the micro-blog client device 100 further includes a buffer module 106 configured to record an identifier of a micro-blog message with a favorite tag into a local buffer list. In this embodiment, a pool is set in the buffer module 106 to store micro-blog message(s) pulled by the micro-blog client device 100. A portion of storage for undesired micro-blog messages may be released when the number of the micro-blog messages in the pool reaches to a set threshold. In pulling a micro-blog message from the server 100, it is determined whether the micro-blog message to be pulled exists in the pool, and if the micro-blog message exists in the pool, the message is pulled directly from the pool instead of the server 200. Therefore, the traffic in the network may be saved and the load of the server may be reduced.

A favorite list, i.e. the local buffer list, is also maintained in the buffer module 106. When the micro-blog client device 100 set a favorite tag for a micro-blog message added as favorite by a user, the micro-blog client device 100 records an identifier of the micro-blog message with the favorite tag into the local buffer list. When the micro-blog message added as favorite needs to be presented, for example, when the user looks through pages in a Web browser or pulls a scroll bar in a micro-blog message Tab page to read a micro-blog message pulled before, the micro-blog client device 100 determines whether the micro-blog message to be presented is added as favorite, that is, the micro-blog client device 100 checks whether the identifier of the micro-blog message exists in the local buffer list, and if the identifier of the micro-blog message exists in the local buffer list, a favorite tag is set for the micro-blog message; otherwise, it is indicated that the micro-blog message is not added as favorite by the user.

In an embodiment, as shown in FIG. 4, the micro-blog client device 100 further includes a pulling module 108 configured to trigger a pulling of a micro-blog message, to acquire a favorite list from the server 200 and to pull the micro-blog message according to the favorite list.

In an embodiment, the pulling module 108 calls a class for managing strategic pulling of favorite micro-blog messages in a class of favorite management logic through the control of favorite page, so as to pull a message. The class of favorite management logic hands the pulling action to a favorite logic executer to execute the pull action. A class for executing the pulling of favorite micro-blog messages in the underlying favorite manager is called to pull the favorite list and acquire an identifier of a micro-blog message added as favorite in the list.

In an embodiment, the pulling module 108 is configured to determine that whether the favorite list is pulled successfully, and if the favorite list is not pulled successfully, a failure prompt is displayed; if the favorite list is pulled successfully, it is further determined whether the number of favorites in the favorite list is 0, if the number of favorites is 0, it is displayed that the number of favorites is 0; otherwise, the micro-blog message(s) recorded in the favorite list is pulled. In pulling a micro-blog message recorded in the favorite list, the micro-blog message is pulled from the local pool firstly, and if the micro-blog message can not be pulled from the local pool, the micro-blog message is pulled from the server 200. Subsequently, it is determined that whether the micro-blog message is pulled successfully, and if it is failed, a failure prompt is displayed; otherwise, the pulled micro-blog message is presented on a page.

In an embodiment, as shown in FIG. 4, the micro-blog client device 100 further includes a comparing module 110 configured to compare the favorite list with the local buffer list to acquire an identifier of a micro-blog message which is recorded in the favorite list but not recorded in the local buffer list.

The micro-blog message which is recorded in the favorite list but not recorded in the local buffer list is a newly added favorite. In the embodiment, the buffer module 106 is further configured to record the identifier acquired by the comparing module 110 into the local buffer list. The tagging module 104 is further configured to update the favorite tag for the micro-blog message according to the acquired identifier.

In an embodiment, the micro-blog client device 100 may further configured to cancel a micro-blog message from favorite. The operation responding module 102 is further configured to acquire an instruction from a user for canceling a micro-blog message from favorite, and to send the instruction to the server 200. The tagging module 104 is further configured to remove the favorite tag for the micro-blog message which is canceled from favorite by the user. The buffer module 106 is further configured to remove, from the local buffer list, the identifier of the micro-blog message which is canceled from favorite by the user. The message storage module 202 is further configured to remove, from the favorite list, the identifier of the micro-blog message which is canceled from favorite by the user.

As mentioned above, the user operates a control of canceling from favorite to trigger an instruction for canceling from favorite. After the user cancels a micro-blog message from favorite, the server 200 correspondingly removes, from the favorite list, the identifier of the micro-blog message which is canceled from favorite. When the user enters the favorite page again, the micro-blog message which is canceled from favorite is not pulled according to the favorite list.

As will be understood by those skilled in the art, all of or part of the processes of the above method may be implemented by a related hardware instructed by a computer program. The computer program may be stored in a computer-readable storage medium and when executed, the processes of the above method may be performed. The storage medium may be a magnetic disk, an optical disk, a Read-Only Memory (ROM), a Random Access Memory (RAM) and the like.

Although the above embodiments are described in detail, they are only a few embodiments of the invention and may not be understood as limiting the scope of the invention. It should be noted that improvements and variations could be made by those skilled in the art without departing from the concept of the present invention, and therefore fall within the scope of the present invention. Thus, the scope of protection of the invention should be defined by the appended claims.

1. A method for adding a micro-blog message as favorite, the method implemented at a micro-blog client device, the micro-blog client device communicatively coupled to a communication network, the method comprising:
in response to a request for adding the micro-blog message as favorite, setting, by the micro-blog client device, a favorite tag for the micro-blog message; and
sending, by the micro-blog client device via the communication network, an identifier of the micro-blog message and the favorite tag to a server.

2. The method for adding a micro-blog message as favorite according to claim 1, wherein after setting the favorite tag, the method further comprises:
recording, by the micro-blog client device, the identifier of the micro-blog message with the favorite tag into a local buffer list.

3. The method for adding a micro-blog message as favorite according to claim 2, further comprises:
triggering, by the micro-blog client device, a pulling of the micro-blog message;
acquiring, by the micro-blog client device, a favorite list from the server, wherein the identifier of the micro-blog message with the favorite tag is recorded in the favorite list; and
pulling, by the micro-blog client device, the micro-blog message according to the favorite list.

4. The method for adding a micro-blog message as favorite according to claim 3, wherein after pulling the micro-blog message, the method further comprises:
comparing, by the micro-blog client device, the favorite list with the local buffer list to acquire an identifier of a micro-blog message which is recorded in the favorite list but not recorded in the local buffer list; and
recording, by the micro-blog client device, the acquired identifier into the local buffer list and updating, by the micro-blog client device, the favorite tag for the micro-blog message according to the acquired identifier.

5. The method for adding a micro-blog message as favorite according to claim 1, further comprises:
acquiring, by the micro-blog client device, an instruction from the user for canceling a micro-blog message from favorite; and
removing, by the micro-blog client device, the favorite tag for the micro-blog message which is canceled from favorite by the user, and removing, by the micro-blog client device, from the local buffer list, the identifier of the micro-blog message which is canceled from favorite by the user.

6. The method for adding a micro-blog message as favorite according to claim 1, wherein after sending the identifier of the micro-blog message and the favorite tag to the server, the method further comprises:
recording, by the server, the identifier into a favorite list.

7. The method for adding a micro-blog message as favorite according to claim 6, further comprises:
sending, by the micro-blog client device, an instruction from a user for canceling a micro-blog message from favorite to a server; and
removing, by the server, from the favorite list, the identifier of the micro-blog message which is canceled from favorite by the user.

8. A micro-blog client device, comprising:
one or more processors;
a memory; and
one or more modules stored in the memory and to be executed by the one or more processors, the one or more modules comprising:
an operation responding module configured to acquire an instruction from a user for adding a micro-blog message as favorite; and
a tagging module configured to set a favorite tag for the micro-blog message added as favorite by the user, and to send an identifier of the micro-blog message with the favorite tag to a server via a communication network.

9. The micro-blog client device according to claim 8, further comprising a buffer module configured to record the identifier of the micro-blog message with the favorite tag into a local buffer list.

10. The micro-blog client device according to claim 9, further comprising:
a pulling module configured to trigger a pulling of the micro-blog message, to acquire from the server a favorite list in which the identifier of the micro-blog message with the favorite tag is recorded, and to pull the micro-blog message according to the favorite list.

11. The micro-blog client device according to claim 10, further comprising a comparing module configured to compare the favorite list with the local buffer list to acquire an identifier of a micro-blog message which is recorded in the favorite list but not recorded in the local buffer list; wherein the buffer module is further configured to record the identifier acquired by the comparing module into the local buffer list, and the tagging module is further configured to update the favorite tag for the micro-blog message according to the acquired identifier.

12. The micro-blog client device according to claim 8, wherein:
the operation responding module is further configured to acquire an instruction from the user for canceling a micro-blog message from favorite;
the tagging module is further configured to remove the favorite tag for the micro-blog message which is canceled from favorite by the user; and
the buffer module is further configured to remove, from the local buffer list, the identifier of the micro-blog message which is canceled from favorite by the user.

13. A system for managing micro-blog messages as favorite via a network, the system comprising a micro-blog client device and a server wherein:
the server is configured to store a plurality of micro-blog messages and store an identifier of one of the plurality of micro-block messages in a favorite list associated with the micro-blog client device in response to receiving via the network the identifier from the micro-blog client via the network; and
the micro-blog client is configured to receive the plurality of micro-blog messages via the network and to transmit the identifier of the one of the plurality of micro-blog messages in response to a request to tag the one of the plurality of micro-blog messages as a favorite.

14. A method for managing micro-blog client messages implemented at a server, wherein the server is communicatively coupled to a network, the method comprising:
receiving by the server via the network a plurality of micro-blog client messages wherein the plurality of micro-blog client messages are received from a multiplicity of micro-blog client devices;
storing by the server each of the plurality of micro-blog client messages;
in response to receiving from a one of the multiplicity of micro-blog client devices via the network an identifier corresponding to a one of the plurality of micro-blog messages, updating by the server a favorite list with a reference corresponding to the identifier of the one of the plurality of the micro-blog messages; and
transmitting by the server the one of the plurality of micro-blog messages including an indication that the one of the plurality of micro-blog messages was tagged as a favorite.

15. The method of claim 14, wherein transmitting the one of the plurality of micro-blog messages is in response to receiving via the network a request from the one of multiplicity of micro-blog client.

16. The method of claim 14 further comprises receiving a remove request from the one of the multiplicity of micro-blog clients wherein the remove request includes an identifier of a micro-blog message.

17. The method of claim 16 further comprises based on the identifier removing from the favorite list a reference corresponding to the identifier.
